(19) United States
(12) Patent Application Publication
(10) Pub. No.: US 2008/0073283 A1
(43) Pub. Date: Mar. 27, 2008

(54) Magnetic Separator for Water Treatment System

(76) Inventor: Steven L. Cort, Cary, NC (US)

Correspondence Address: Coats & Bennett, PLLC/Michael deAngeli, 1400 Crescent Green, Suite 300, Cary, NC, 27581, US

(21) Appl. No.: 11/862,767

(22) Filed: Sep. 27, 2007

Related U.S. Application Data
(60) Provisional application No. 60/847,372, filed on Sep. 27, 2006.

(51) Int. Cl. B03C 1/30; B03C 1/02

(52) U.S. Cl. 210/695; 210/222; 210/223

(57) ABSTRACT

A magnetic separator for use in water treatment. Magnetic floc collected from water by the magnetic separator and delivered to a shearing device. Sheared slurry of magnetic seeds and sludge returned to same magnetic separator for extracting the seeds from the sludge and returning the seed to the water for reuse.

### CROSS-REFERENCE TO RELATED APPLICATION

This application claims priority under 35 U.S.C. § 119(e) from the following U.S. provisional application: Application Ser. No. 60/847,372 filed on Sep. 27, 2006. That application is incorporated in its entirety by reference herein.

### FIELD OF THE INVENTION

The present invention relates to water treatment, particularly to the use of magnetic seeding and separation to clean water.

### BACKGROUND OF THE INVENTION

Briefly, “magnetic seeding and separation” technology as referred to herein involves adding a magnetic seed material to water that contains fine pollutant particles. The magnetic seed material is attached under agitation to the pollutant particles with an organic flocculating agent. The flocculated particles are now magnetic and are removed from the water with either permanent magnets or electromagnets.

A known commercial application of magnetic seeding is the “Sirofloc” technology used in Australia to clean drinking water. This process uses the absorption capacity of magnetite to remove color and other pollutants from water. The spent magnetic seed material magnetite settles out by gravity in a clarifier and then is pumped to a magnetite regeneration step that cleans the magnetite so it can be reused.

Another known commercial application of magnetic seeding is the “Comag” process described in Wechsler U.S. Pat. No. 6,099,738. This process has a high gradient magnetic field collector that uses powerful electromagnets. Once the collector becomes loaded with solids, it is backwashed with air and water to flush the magnetic seed material to a cleaning process. The cleaned magnetic seed material is then reused in the treatment process. The electromagnets in the Comag system have to be de-energized for cleaning. The cleaning process interrupts the flow of water for treatment and high solids loading limits the ability to backwash the system.

### SUMMARY OF THE INVENTION

The present invention entails a moving magnetic collector used in a water treatment system. The magnetic collector collects magnetic floc from water being treated. The magnetic floc is removed from the magnetic collector and sheared, producing sheared slurry of magnetic seeds and sludge. The same magnetic collector that collected the magnetic floc then collects the separated magnetic seed.

Further, the present invention entails a method of treating water including collecting magnetic floc from a moving magnetic collector. Thereafter, the magnetic floc is removed from the moving magnetic collector and directed to a shearing device where the magnetic floc is sheared to produce sheared slurry of magnetic seeds and sludge. Then the method includes collecting the magnetic seeds on the same moving magnetic collector that collected the magnetic floc.

### BRIEF DESCRIPTION OF THE DRAWINGS

The invention will be better understood if reference is made to the accompanying drawings, in which:

FIG. 1 is a schematic plan view of an apparatus according to one aspect of the invention, with a magnetic separator device mounted in the upper portion of a flocculation tank;

FIG. 2 is a schematic end view of one embodiment of the magnetic separator device;

FIG. 3 is a more detailed schematic view of FIG. 2 showing a portion of a magnetic drum and scraper assembly used to first separate magnetic floc from the water stream and then to return cleaned magnetic seed to the floc tank for reuse;

FIG. 4 is a schematic side view of a tank and related equipment for carrying out the method of the invention; and

FIGS. 5a, 5b and 5c, show details of scraper designs.

### DETAILED DESCRIPTION OF THE INVENTION

The present invention is in the technical field of removing fine particles from water. The fine particles can include metal precipitates, organic solids, inorganic solids, clays, silts, oil and grease and any other hard to remove fine solids. The invention is applicable to industrial wastewater, municipal wastewater, potable water, combined sewer overflow, storm water, process water, cooling water, ground water, and any other waters that require clarification to remove fine particles. The term “water” as used herein includes water and all forms of wastewater.

The invention relates to the use of magnetic seeding and separation technology where a fine magnetic seed material is added to the water along with an organic flocculating polymer. The organic flocculating polymer binds the non-magnetic pollutant particles to the magnetic seed material and then the composite particle, or magnetic floc. In some embodiments, a flocculating polymer may not be used but rather the sorption properties of the magnetic particles are employed to extract pollutants from the water and attaché the pollutants to the magnetic particles. In some cases, certain scalants may be removed by employing magnetic particles whose surfaces provide sites for sacrificial scaling thus preventing or reducing scaling on downstream equipment. In any case, the invention includes utilizing the magnetic properties of the magnetic particles, bound with pollutants—be they in the form of flocs, particles with pollutants sorbed therewith, or scaled magnetic particles—to magnetically remove the pollutants from the water.

Collectors employing magnetized surfaces are used to attract magnetic particles and their burden of pollutants. The magnetized surfaces are generally moving magnetized surfaces to facilitate continuous transport of collected particles out of the water. The surfaces are equipped with permanent magnets or electromagnets to provide the required magnetic strength to remove the magnetic particles. The magnetic strength of the magnets used ranges approximately 0.1 to 10 tesla. Permanent magnets may be more commonly 0.5 to 1.5 tesla while electromagnets may be configured with a strength up to about 10 tesla.

The magnetically collected magnetic floc are further processed to form separate streams of sludge to be ejected as a waste product and cleaned magnetic seed to be recycled and reused in the water treatment system.

The process of using magnetic seeding and separation technology for removing fine pollutant particles sometimes involves attaching the fine pollutant particles to the magnetic seed material with a flocculating polymer. In a traditional flocculation process, the aim is to produce a large floc that will settle rapidly by gravity. To assure this floc formation, it is important to have the proper mixing energy. The measure of this mixing energy is referred to as the root-mean-square velocity gradient G measured in negative seconds (sec⁻¹). For optimum floc formation in a gravity separation situation, the G value should generally not exceed approximately 50 sec⁻¹. Exceeding this level increases the speed of mixing and the formation of microfloc, but will shear the floc and prevent the development of large macroflocs that will settle rapidly.

Magnetic seeding and separation is different. Since the size of floc is not important because gravity settling is not employed, the G value can be greatly increased because all that is needed is for the magnetic and non-magnetic particles to collide quickly in the presence of the flocculating polymer. Therefore the G value can be increased to about 100 sec⁻¹ and higher, which will speed the flocculation and therefore clarification process. The G value should generally be greater than about 50 sec⁻¹ and less than about 1000 sec⁻¹ but more preferably in the range of about 100 to about 500 sec⁻¹ in magnetic seeding and separation.

Various forms of magnetic seed material may be used. Among the forms is magnetite, a ferromagnetic form of ferric oxide. Other forms include but are not limited to zero valent iron, ferrosilicon, maghemite, jacobsite, trevorite, magnesioferrite, magnetic sulfides like pyrrohotite and greigite, and any other ferromagnetic and ferremagnetic materials that show strong attraction to a magnetic field.

Magnetic seed particle sizes in the range of 30 to 50 microns, as would be characteristic of 90% of material passing a 355 mesh, may be commonly used as magnetic seed for binding or sorbing pollutant particles for removal. Further, for various sorption processes, those that for example may be useful for removing very fine or nano pollutant particles, magnetic seed sizes may range down to approximately 20 nanometers. Magnetic seeding in treatment vessels such as flocculation tanks is typically done at a concentration by weight of magnetic seed of about 0.5 to 1% and which in some cases may up to about 3-5%.

### Tank Design

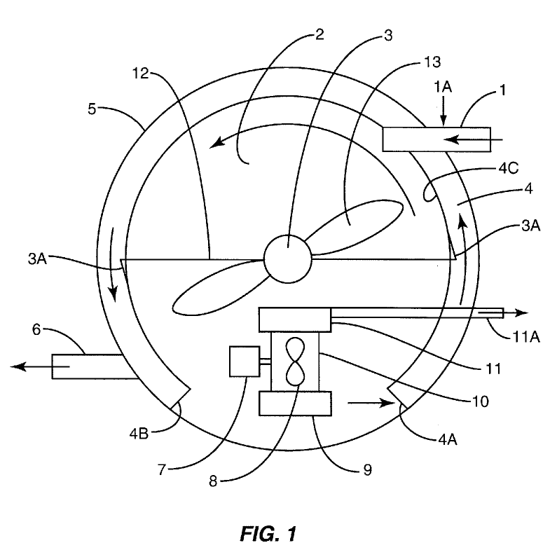

With reference to the drawings, a final magnetic collector 4 is configured to maximize the residence time in the flocculation chamber while maximizing the surface area of the final magnetic collector. One way to do this is to locate the floc chamber in the center and bottom of a cylindrical tank and then to extend the final collector around the perimeter of the upper regions of the tank, as illustrated in FIG. 1. In this way, the floc chamber occupies a maximum volume of the tank, increasing the residence time during which the flocculent effectively attaches fine pollutant particles to the magnetite, or magnetic seed to form composite particles or magnetic floc. This allows the use of magnetic techniques for removal of the fine pollutant particles from the water stream.

The tank can be a circular cylindrical tank with a circular final magnetic collector 4 extending around the perimeter of an upper portion of a treatment tank 5, as illustrated in FIG. 1. Disposing final magnetic collector 4 around the perimeter of tank maximizes the surface area of the collector, effectively slowing the motion of the composite particles to less than 18 inches per second and increasing their residence time in the collector. A speed faster than 18 inches per second will tend to dislodge the magnetic particles from magnetized surfaces of final magnetic collector 4.

Scaling up the tank design for high flow rate applications requires a larger final magnetic collector 4 which is most easily accommodated by placing it in proximity to the perimeter of the tank 5. The efficiency of final magnetic collector 4 is reported as the Surface Overflow Rate (SOR) which is measured in gallons per minute per square foot (gpm/ft²) of surface area. The SOR for a traditional gravity clarifier is 0.25 to 1.00 gpm/ft². The SOR for the present invention ranges from 10 gpm/ft² to 300 gpm/ft² which makes magnetic separation technology more effective than gravity clarification.

FIG. 1 shows a typical layout for positioning of key treatment elements. The important features include provision of a cylindrical tank 5 which is strong and easy to construct, whereby a large portion 2 of the tank volume is dedicated to the flocculation of pollutants to magnetic seed material, and provision of a long flow path in final magnetic collector 4. In some applications, a square or rectangular tank may be utilized in the process since a final magnetic collector 4 can be configured such that it can be disposed along one side of the tank. While more expensive to construct, a square tank has some improved flocculation characteristics because of improved mixing in that it does not require baffles to increase turbulence as may sometimes be the case with circular tanks.

Referring in particular to FIG. 1, water flows into the tank through a pipe 1 where flocculating polymer 1A is added. The water flows into a central flocculation chamber 2 that contains magnetic seed particles (typically magnetite), so that composite magnetic particles, or magnetic floc, formed are made up of the pollutant particles bound by the flocculent to the magnetic seed. A flocculation mixer motor 3 and mixer blade 13 are provided to ensure thorough mixing. Water then flows through an opening 4A into an outer shell which contains a final magnetic collector 4 that extends about the perimeter of the tank 5. In this space any of a variety of different types of final magnetic collectors 4 can be installed. In one embodiment, the magnetic seed material or particles will be collected along an inner magnetized surface 4C closest to the flocculation chamber 2 and moved by a mechanical scrapers 3A disposed on ends of arms 12 driven by flocculation motor 3. Clarified water overflows out pipe 6 while scrapers 3A urge magnetically collected seeded floc along surface 4C and are returned to tank 5 where the floc are ultimately collected on drum 9 of a magnetic seed cleaning system disposed in the tank. A motor 7 drives two magnetic drum devices 9 and 11. The first magnetic drum 9 collects magnetic floc and directs the magnetic floc to a shear device or tank 10 that includes a shear mixer 8 that shears the magnetic particles away from the non-magnetic pollutant particles producing a slurry of magnetic seeds and sludge. These materials are separated magnetically on drum 11 with the magnetic seed material going back into the flocculation chamber for reuse and the non-magnetic pollutants, or sludge, being discharged for disposal 11A. The location of the first magnetic drum 9 can be advantageously placed in front of the opening 4A so that is removes magnetic particles before they reach the final magnetic collector 4 as well as receiving scraped floc from the final collector. This dual duty for the first magnetic drum or collector 9 reduces the solids loading on the final magnetic collector 4. The first magnetic collector 9 that removes the magnetic floc for seed separation and cleaning is typically shown as a magnetic drum but can be in other configurations.

### Horizontal Shear Device

A first magnetic drum collector is used to collect the composite magnetic particles, or magnetic floc, comprising the pollutants to be removed, the flocculant, and the magnetic seeds. The first magnetic drum collector or a second magnetic drum collector can be used clean the pollutant and flocculant from the magnetic seed material so the seeds can be reused. For example, a first magnetic drum rotating about a horizontal axis is submerged into the floc tank where the first magnetic drum collects the composite magnetic floc. Typically, the magnetic floc is scraped off the magnetic drum into a vertical shear tank where fine pollutant particles are detached from the magnetic seed by a vigorous mixing action. The clean magnetic seed is then collected on a second magnetic drum collector and scraped back into the floc tank.

Mounting the shear tank in a vertical position causes a surging in the tank, especially if the tank is square, when the magnetic floc is scraped into the tank. This surging action causes an uneven amount of magnetic seed to be deposited on the second magnetic drum collector. There are also some layout problems caused by use of a vertical shear tank; notably, if a relatively wide first magnetic drum collector is used for removing magnetic floc from the floc tank, it will not match up well to a much narrower vertical shear tank. A better configuration is to mount the shear tank in a horizontal position, parallel to the first magnetic drum collector, and to make the shear tank of similar width to the first and second magnetic drum collectors. Doing so also avoids the surging found in a vertically mounted shear tank.

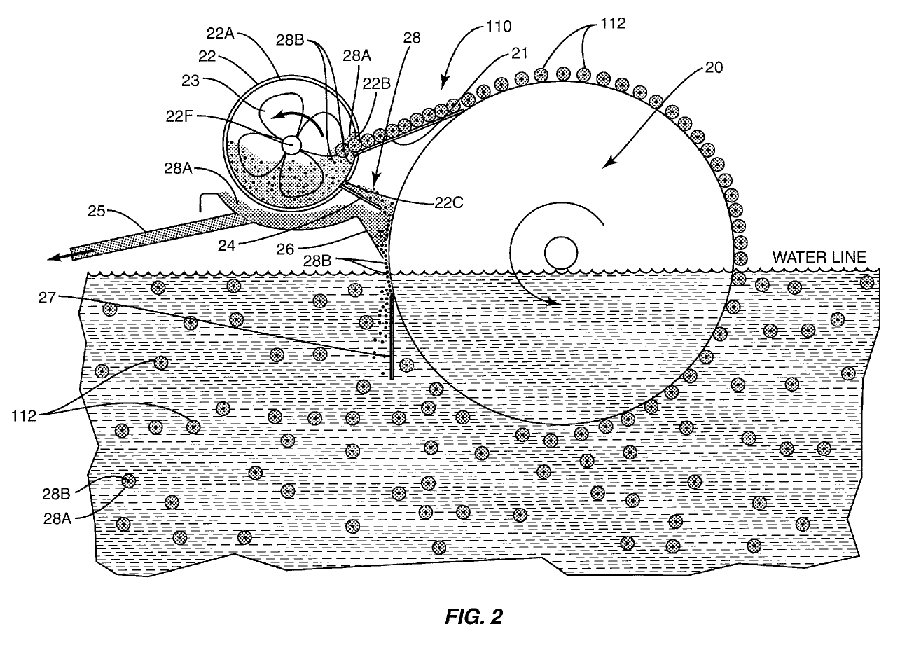

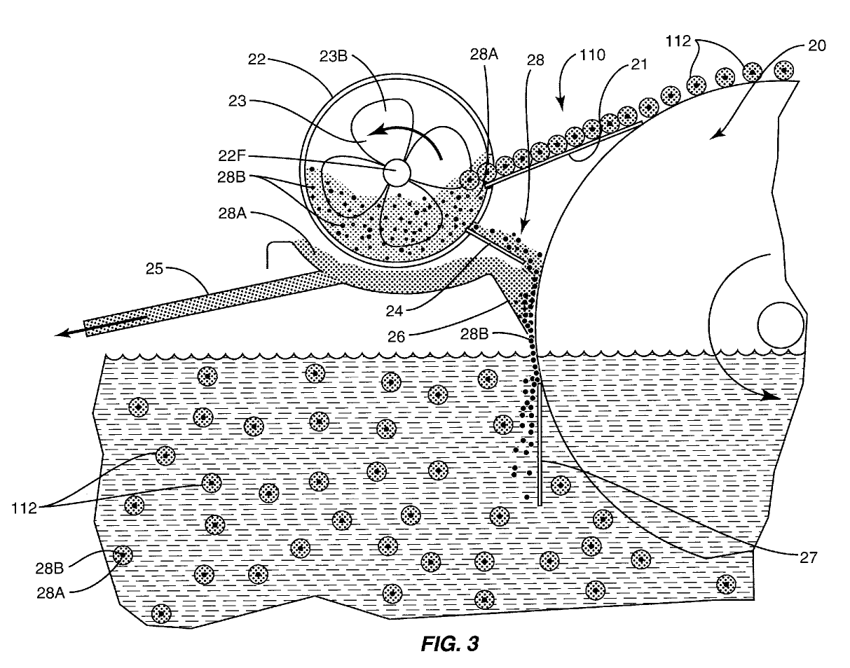

FIG. 2 shows a horizontal shear tank 22 juxtaposed to a rotating magnetic drum 20 which removes composite magnetic particles from the flocculation chamber for cleaning the pollutant particles and flocculant from the magnetic seed particles. The composite particles are scraped from the surface of drum 20 by a scraper 21 and flow down its upper surface into the horizontal shear tank 22. Inside this tank is a high-shear powerful mixer 23 that causes separation of the magnetic seed magnetite, for example from the pollutant particles. The sheared slurry flows out of the tank 22 through a slot onto a trough 24 and back onto the magnetic drum 20. The magnetic particles are attracted to the surface of the drum 20, while a scraper 26 pressing against the magnetic drum 20 causes the water that contains the pollutants to overflow into a discharge pipe 25 for disposal. See FIG. 3 for an enlarged view. The pressed magnetic seed is then scraped 27 off the magnetic drum so the magnetic seed can be returned to the floc chamber to be reused.

### Magnetic Drum Design

The goal is to use only one magnetic collector to remove magnetic floc from the floc tank and return cleaned magnetic seed into the floc tank. Magnetic floc 112 collected on the magnetic collector are scraped off by a first removal device, or scraper, and transferred in the form of a swath 110 into a shearing device. The shearing device shears the magnetic floc to free the magnetic seed from the floc, producing a slurry of magnetic seeds, flocculant, and pollutants, the flocculant and pollutants essentially forming a sludge It is necessary to separate the magnetic seed from the sludge so the magnetic seed can go back into the floc tank for re-use, while the separated sludge is disposed. It was observed that a blade, or retainer, pressing against the magnetic drum will squeeze or compress the magnetic seed together, urging any remaining sludge away from the seed and leaving the seed substantially dry. The sludge will then overflow over the blade, or retainer, to be discharged, while the compressed and substantially dry magnetic seed will be removed by another scraper and returned to the floc tank for re-use. This approach employs the same magnetic collector to remove magnetic floc from the water and to separate the magnetic seed from the sludge after shearing. One magnetic drum is eliminated, which reduces cost, space requirements, and mechanical complexity of the system.

FIG. 3 shows an enlarged detail of FIG. 2, illustrating the manner in which magnetic seed is separated from non-magnetic pollutants. Sheared sludge, referred to sometimes as a sheared slurry of magnetic seeds a sludge, exits through a slot in the horizontal shear tank 22 which contains a shear mixer 23 and flows down a trough 24 back onto the surface of the same rotating magnetic drum 20 that first removed the dirty sludge from the flocculation tank. The magnetic material adheres to the drum and is collected in a wedge-shaped collection area formed by a retainer or trough 26 extending along the surface of the drum 20. The lower end of trough 26 is spaced close to the surface of drum 20, so that it squeezes out water that contains the non-magnetic pollutants while the separated magnetic seed material is attracted to and retained on the surface of the drum 20. The retainer 26 prevents the non-magnetic slurry from going back on the drum and into the flocculation chamber. Rather the slurry overflows the retainer 26 into a sludge collector comprising a discharge pipe 25 for disposal. The magnetic seeds that adhered to the magnetic drum 20 are scraped off its surface by a scraper 27, and drops back into the flocculation chamber for reuse.

### Magnetic Separation as a Batch Process

Previous magnetic separation systems involved continuous flow applications. Here magnetic separation technology is used to treat waste in batches. This will allow all of the treatment functions to be carried out in the same tank, using a single motor and mixing paddle assembly. This has self-evident advantages in terms of space, complexity, and cost.

The motor operates at various speeds, so that the mixer blade can be driven at a slow speed to ensure good mixing and flocculation of the pollutant particles with the magnetic seed material, and at high speed to shear the pollutant particles from the magnetic seed in the cleaning process. The tank assembly includes a controllable source of magnetic field mounted near its bottom, the bottom forming a collection surface. The magnetic field source is operable so that the magnetic field can be applied as necessary. The magnetic field can comprise one or more permanent magnets that are movable toward or away from the collection surface. Alternatively one or more electromagnets that can be powered or depowered correspondingly are mounted adjacent the collection surface.

The treatment process includes the following steps:
a. The tank is filled, the flocculant and magnetic seed particles are introduced, and the mixer driven slowly to flocculate the pollutant particles with the magnetic seed material. At this point the magnetic field is not being applied, so that the magnetic particles are not attracted to the lower collection surface.
b. After a few minutes, the mixer is either turned off, so that the composite particles quickly settle out by gravity, or the mixer is allowed to continue to mix slowly, and the magnetic field is applied. This will separate the composite particles from the treated water, so that they form a sludge collected at the bottom of the tank.
c. A side valve is opened to decant the clarified water out of the tank. This leaves the collected sludge and a small amount of water in the bottom of the tank.
d. The magnetic field is deactivated, releasing the composite magnetic particles from the collection surface, and the mixer is operated at high speed. This shears the pollutant particles from the magnetic seed material.
e. Then the mixer is operated at slow speed and the magnetic field is again applied.
This causes the cleaned magnetic seed magnetite, for example to be held to the bottom of the tank while the waste sludge stays in solution. The bottom valve is then opened to drain out the waste sludge. After the sludge is drained, the valve is closed, the magnets disengaged, and the tank refilled. This method for batch treatment is simple and inexpensive and makes it feasible to use magnetic seeding for small flow applications.

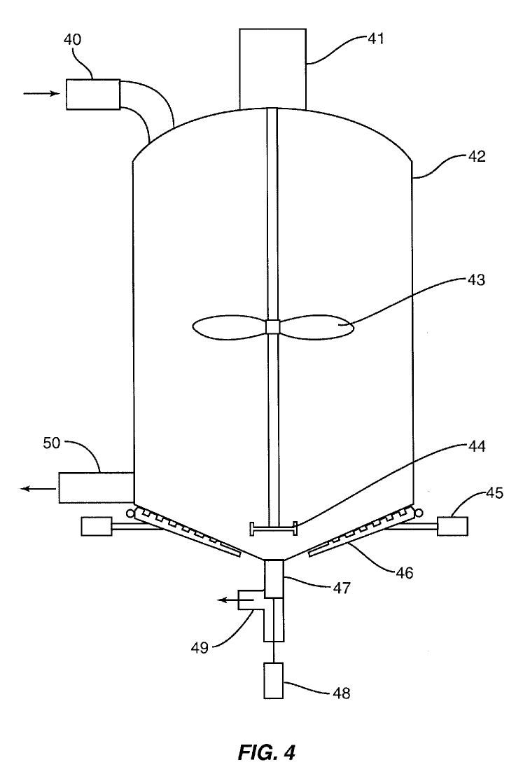

FIG. 4 shows one embodiment of a batch treatment system that uses magnetic seeding and separation technologies, as above. A tank 42 is provided with a mixer assembly, comprising motor 41, paddle or mixing blade 43, and shear blade 44. In this embodiment, the magnetic field is controlled by mounting permanent magnets 46 for controlled motion toward or away from the lower collection surface of the tank; the motion may be powered by air cylinders 45. First the tank 42 is charged with contaminated water through a pipe 40. Magnetite seed material, for example, may be present from prior processes, or may be added if necessary. Once the tank is filled, polymer (flocculant) is added to attach the pollutants to the magnetite. The mixer 41 is operated at slow speed to ensure good mixing while avoiding shearing of the floc as it forms. Once the water is clarified, the magnets 46 at the bottom of the tank are moved close to the collection surface to attract the magnetic particles in the tank. When all the magnetic particles are collected at the bottom of the tank, the clarified water is decanted through a pipe 50 in the side of the tank. Next, the magnets are moved away from the tank to release the magnetite and the mixer 41 is turned back on, now at high speed, as is necessary to shear the magnetic seed from the non-pollutant particles. Next the magnets 46 are moved against the surface of the tank to collect the magnetic seed and the mixer is turned off. A flush mounted valve 47 is opened, preferably with an operator 48 and the non-magnetic pollutants sludge are discharged through pipe 50. The process can now be repeated to treat another batch, that is, with the magnetic seed remaining in the tank during successive operations.

### Scraper Design

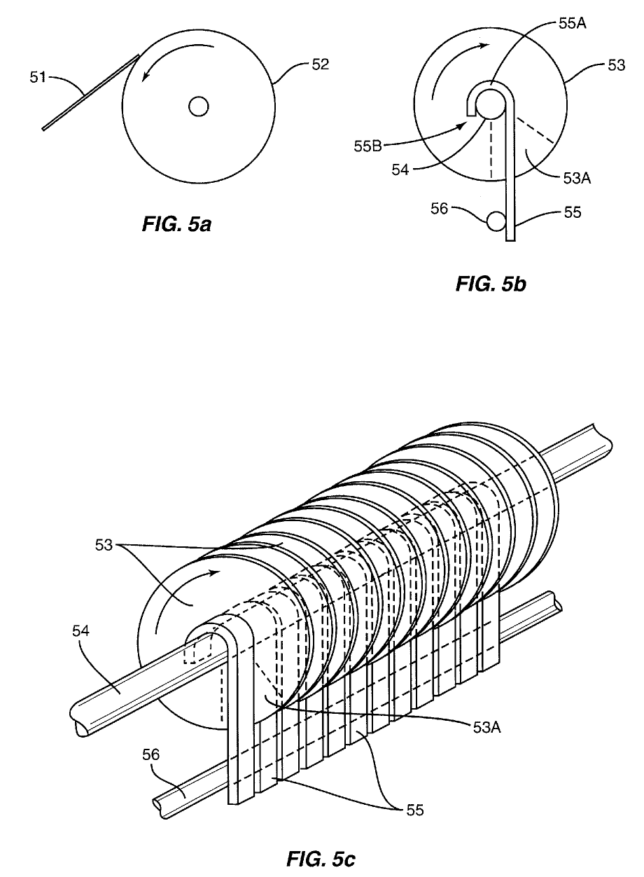

FIG. 5a shows a removal device or scraper 51 that includes a ferromagnetic material disposed such that the scraper is attracted to a magnetic drum 52 to remove collected magnetic floc from the drum. A magnetic attraction, or force, acts between drum 52 and scraper 51, and maintains a constant pressure between the drum and the scraper 51 over the entire length of the scraper, thus providing good scraping efficiency. This also provides a self adjusting feature to allow compensation for wear. The magnetic attraction, or force is independent of wear of the drum 52 or the scraper 51. Thus as either the drum 52 or the scraper 51 wears, the scraper is kept in contact with the drum with essentially the same force. Moreover, the magnetic force has an intensity that is generally constant over the area of contact or approach between the scraper 51 and the drum 52. This facilitates maintaining uniform contact over the area of contact or approach. This uniform contact is also therefore obtainable even in cases where the scraper 51 or drum 52 wears in a pattern that produces irregularities in the contact area. This design enhances the consistent and continuous cleaning of permanent magnet collectors. Scraper 55 is made of non-ferromagnetic material, preferably plastic which is easy to mold, inexpensive and abrasion resistant.

It should be noted, that scraper 51 also functions to convey removed magnetic floc from the magnetic drum 52. That is, since scraper 51 is magnetically held adjacent to or in contact with the magnetic drum 52, magnetic floc scraped from the drum 52 tends to move down the upper surface of scraper 51. Thus, scraper 51 not only removes the magnetic floc from magnetic drum 52, but also directs or channels the removed magnetic floc away from the magnetic drum. As discussed elsewhere herein, the removed magnetic floc is typically directed to a shear device where the magnetic floc is sheared producing magnetic seed and sludge.

FIGS. 5b and 5c show a removal device or scraper 55 that can be easily removed and which does not impede the flow of water between disks of a rotary magnetic collector that is disposed in a tank of water to collect magnetic floc. A plurality of scrapers 55 is preferably disposed between adjacent disks 53, so as to engage and scrape magnetic flocs from the opposed faces of the adjacent disks. Each scraper 55 has a hook end 55A by which it is suspended from a center shaft 54 holding the disks of the magnetic collector. An opening 55B formed by hook end 55A facilitates easy installation and removal of the scraper from above the magnetic collector for convenience. In one embodiment, the magnets are maintained stationary on disk (not shown) sandwiched between two plastic, or other non-magnetic material-based, rotating disks. Sometimes, magnets are omitted from a lower sector of the disks, forming a magnet-free sector 53A on each disk. This facilitates magnetic floc detaching at sector 53A of the disk surface where the scrapers 55 are be located. The scrapers 55 extend radially beyond the magnetic collection disks so that they can engage a stop or retaining bar 56 that prevents each scraper from moving out of the magnet-free sector 53A at the bottom of the magnetic collection disks. Alternatively, magnets may be embedded in a uniformly distributed array in a disk which rotates and from which magnetically-collected material is scraped. Scrapers 55 are hung from the center shaft 54 of the disk collector and mounted in a near vertical position so it does not impede the flow of water through the magnetic disk collector. In one embodiment, the general direction of flow is generally parallel to scrapers 55. Each space between disks includes one scraper, which can be arranged to scrape the opposed surfaces of adjacent disks.

The present invention may, of course, be carried out in other specific ways than those herein set forth without departing from the scope and characteristics of the invention. The present embodiments are therefore to be construed in all aspects as illustrative and not restrictive and all changes coming within the meaning and equivalency range of the appended claims are intended to be embraced therein.

1. A water treatment system comprising:
a. a moving magnetic collector for collecting magnetic floc;
b. a shear device for receiving the magnetic floc and producing a sheared slurry of magnetic seeds and sludge;
c. a removal device for removing the magnetic floc from the moving magnetic collector such that the magnetic floc can be transferred to the shear device;
d. the magnetic collector and shear device being configured such that the magnetic collector collects the magnetic seeds from the sheared slurry; and
e. wherein the same moving magnetic collector collects the magnetic floc and collects the magnetic seeds that have been sheared from the magnetic floc.

2. The water treatment system of claim 1 wherein the moving magnetic collector is at least partially submerged in the water such that the moving magnetic collector can move through the water and collect the magnetic floc from the water.

3. The water treatment system of claim 1 wherein the removal device includes a first scraper for scraping the magnetic floc from the magnetic collector such that the magnetic floc can be directed to the shear device.

4. The water treatment system of claim 3 wherein the first scraper directs the magnetic floc to the shear device.

5. The water treatment system of claim 1 including a retainer disposed adjacent the magnetic collector and cooperating with the magnetic collector to form a collection area for receiving the sheared slurry.

6. The water treatment system of claim 5 wherein the retainer is adapted to cooperate with the moving magnetic drum to compress the sheared slurry and separate the sludge from the magnetic seeds

7. The water treatment system of claim 5 wherein the retainer directs the sludge from the collection area.

8. The water treatment system of claim 1 including a retainer which cooperates with the moving magnetic collector to receive the sheared slurry of magnetic seeds and sludge, compress the sheared slurry, and direct the sludge from the retainer and magnetic collector.

9. The water treatment system of claim 3 including a second scraper for scraping the magnetic seeds from the magnetic collector.

10. The water treatment system of claim 5 including a sludge collector for collecting the sludge from the collection area.

11. A method of treating water comprising;
a. collecting magnetic floc on a moving magnetic collector;
b. removing the magnetic floc from the moving magnetic collector;
c. shearing the magnetic floc to produce a sheared slurry of magnetic seeds and sludge; and
d. collecting the magnetic seeds on the same moving magnetic collector.

12. The method of claim 11 wherein collecting the magnetic floc includes at least partially submerging the moving magnetic collector in the water, moving the magnetic collector through the water, contacting the magnetic floc with the magnetic collector, and adhering the magnetic floc to the collector.

13. The method of claim 11 wherein shearing the magnetic floc is performed by a shear device disposed adjacent the moving magnetic collector and the method includes scraping the magnetic floc from the moving magnetic collector and directing the magnetic floc into the shearing device.

14. The method of claim 13 including directing the sheared slurry of magnetic seeds and sludge to a collection area adjacent the moving magnetic collector where the sheared slurry is held in contact with the moving magnetic collector.

15. The method of claim 14 including compressing the sheared slurry held in the collection area.

16. The method of claim 15 wherein compressing the sheared slurry causes the sludge to be separated from the magnetic seeds

17. The method of claim 11 including directing the sheared slurry to a collection area adjacent the moving magnetic collector, attracting the magnetic seeds to the moving magnetic collector thereby separating the magnetic seeds from the sludge, and directing the sludge from the collection area.

18. The method of claim 17 including scraping the magnetic seeds from the moving magnetic collector and recycling the magnetic seeds.

19. The method of claim 11 including mixing the magnetic seeds and flocculant with the water to form magnetic floc and wherein the magnetic seed is magnetite or other ferromagnetic material.
